(19) United States
(12) Patent Application Publication
(10) Pub. No.: US 2003/0205319 A1
(43) Pub. Date: Nov. 6, 2003

(54) Laminated packaging materials and packaging containers produced therefrom

(76) Inventors: Jorgen Bengtsson, Lund (SE); Matts Bentmar, Svedala (SE); Mikael Berlin, Lund (SE); Ib Leth, Kavlinge (SE)

Correspondence Address: Brain P. O'Shaughnessy, BURNS, DOANE, SWECKER & MATHIS, L.L.P., P.O. Box 1404, Alexandria, VA, 22313-1404, US

(21) Appl. No.: 10/447,235

(22) Filed: May 29, 2003

Related U.S. Application Data
(63) Continuation of application No. 09/784,053, filed on Feb. 16, 2001.
Application No. 09/784,053 is a division of application No. 09/265,414, filed on Mar. 10, 1999, now abandoned.
Application No. 09/265,414 is a continuation-in-part of application No. 09/065,065, filed on Oct. 9, 1998, now abandoned.
Application No. 09/065,065 is a 371 of international application No. PCT/SE96/01403, filed on Oct. 30, 1996.
(63) Continuation-in-part of application No. 09/254,144, filed on May 21, 1999, now abandoned.
Application No. 09/254,144 is a 371 of international application No. PCT/SE97/01462, filed on Sep. 1, 1997.

(30) Foreign Application Priority Data
Mar. 10, 1998 (SE) 9800769-3
May 13, 1998 (SE) 9801675-1
Sep. 4, 1996 (SE) 9603211-5

(51) Int. Cl. B32B 31/00

(52) U.S. Cl. 156/278; 156/244.11

(57) ABSTRACT

The invention relates to a method of producing a laminated packaging material including a core layer of paper or paperboard and a barrier layer applied on one side of the core layer. The invention also relates to a laminated packaging material produced according to the method, as well as a packaging container which is produced from the laminated packaging material.

This application is a continuation-in-part of Ser. No. 09/065,065, filed Oct. 9, 1998, which is a 35 U.S.C.371 application of PCT/SE96/01403;, filed Oct. 30, 1996, which claims the benefit of priority under 35 U.S.C. 119 of Swedish application 9503817-0, filed Oct. 30, 1995, the contents all of which are hereby incorporated by reference. This application also claims the benefit of priority under 35 U.S.C. 119 of Swedish applications 9800769-3, filed Mar. 10, 1998, and 9801675-1, filed May 13, 1998, the contents both of which are hereby incorporated by reference.

### BACKGROUND OF THE INVENTION

1. Field of the Invention

The present invention relates to methods of producing a laminated packaging materials comprising a core layer of paper or paperboard and a barrier layer applied on at least one side of the core layer. The present invention also relates to a laminated packaging material produced according to the method, as well as to packaging containers which are produced from the laminated packaging material. One embodiment provides packaging laminates in which starch or a starch derivative is used as a barrier layer.

2. Description of the Related Art

It is well-known in the packaging industry to employ laminated packaging material of a single-use nature for packing and transporting liquid foods. Normally, such laminated packaging materials are built up from a configurationally rigid but foldable core layer consisting of, for example, paper or paperboard in order to achieve good mechanical configurational stability. Liquid-tight coatings of plastic are applied on both sides of the core layer and effectively protect the core layer of liquid-absorbing fiber from penetration by moisture. These outer layers normally consist of a thermoplastic, preferably polyethylene, which moreover impart to the packaging material superior thermosealing properties, whereby the packaging material may be converted into finished packages with the desired geometric configuration.

However, laminated packaging material consisting solely of paper or paperboard and liquid-tight plastic lacks tightness properties vis-a-vis gases, in particular oxygen gas. This is a major drawback in the packing of many foods whose shelf-life deteriorates dramatically when in contact with oxygen gas. In order to supplement the packaging material with a barrier against gases, especially oxygen gas, it is known in the art to apply a layer possessing superior oxygen gas tightness properties, for example aluminum foil or polyvinyl alcohol, on that side of the core layer which is intended to face in towards the inside of the package.

In comparison with aluminum foil, polyvinyl alcohol enjoys many desirable properties, with the result that it is preferred as barrier material in many contexts. Among these, mention might be made of the polyvinyl alcohol's superior strength properties, compatibility with foods and economic value, together with its extremely good oxygen gas barrier properties. Moreover, it has been considered to be expedient, in certain cases from the point of view the environment and recycling, to replace Aluminum foil as the gas barrier material in food packages.

Like many other conceivable barrier or adhesive polymers such as, for example, ethylene vinyl alcohol, starch, starch derivative, carboxy methyl cellulose and other cellulose derivatives or mixtures thereof, polyvinyl alcohol is suitably applied by means of a coating process, i.e. in the form of a dispersion or aqueous solution which, on application, is spread out to a thin, uniform layer on the substrate and thereafter dried. One drawback in this process however is that an aqueous polymer dispersion or polymer solution of, for example, polyvinyl alcohol with an addition of EAA which is applied on a core layer of paper or paperboard penetrates into the liquid-absorbing fibers of the core layer. In connection with the removal of water for drying and possibly for curing the applied barrier layer, the core layer is also subjected to elevated temperatures for drying, and as a result the risk of undesirable crack formation in the paperboard or paper layer, respectively, increases as a result of the moisture content which is difficult to adjust, and the drying which takes place in this layer.

Swedish Patent No. 440519 proposed including a thickening agent such as alginate to reduce penetration of water into the board. The use of PVOH as a barrier material applied over a polymer layer preventing crack formation and smoothing the board surface was disclosed in PCT/SE96/01237.

Another drawback is that the polyvinyl alcohol is moisture sensitive and rapidly loses its barrier properties when it is exposed to a damp environment. This inconvenience was previously obviated according to WO97/22536 by combining the polyvinyl alcohol with one or more per se known food-approved polymers, for example ethylene acrylic acid copolymer (EAA) or styrene butadiene copolymer. These advantageously form, in combination with polyvinyl alcohol, a coherent, well-integrated layer possessing superior gas barrier properties, in particular oxygen gas barrier properties, at the same time as the desired superior gas barrier properties of the polyvinyl alcohol are retained even in a damp environment.

WO97/22536 disclosed that polyvinyl alcohol mixed with EAA-ethylene copolymer or like material could be dispersion coated onto a paperboard previously coated with a polymer and thereafter could be dried and cured at temperatures of up to 170° C. to form a laminated packaging material with a very good barrier property.

Another drawback in the employment of, for example, polyvinyl alcohol as barrier layer instead of aluminum foil is that, on storage of light-sensitive foods, it is necessary in many cases also to incorporate into the packaging material a light barrier of some type. Granted, a core layer of paper or paperboard does not (to the naked eye) allow the passage of any light, but light in invisible wave length ranges nevertheless penetrates through from the outside of a packaging container to the packed food product and may have a negative effect on it from the point of view of shelf-life. The employment of aluminum foil in the packaging material enjoys that advantage that the Aluminum foil in itself constitutes a good barrier against both gases and against light. On the other hand, polyvinyl alcohol is as good as completely transparent even in mixtures with a hydrophobic polymer such as ethylene acrylic acid copolymer or styrene butadiene copolymer. The admixture of conventional light barriers, such as carbon black and titanium dioxide into any of the plastic layers included in the laminated packaging material according to WO97/22536 is per se possible, but would entail an aesthetically unattractive appearance in the package.

Yet a further drawback inherent in the laminated packaging material including barrier layers of, for example, polyvinyl alcohol possibly together with another polymer as described in WO97/22536 is that this packaging material cannot be produced employing the same production equipment as in the production of packaging material using aluminum foil as the barrier layer, which involves capital investment costs for new production equipment.

As indicated above PVOH has environmental benefits as a barrier material. In addition to such synthetic materials, the possibility of using natural and biodegradable polymers (biopolymers) such as starch and starch derivatives, as gas barrier materials has been investigated.

It is previously known that starch possesses some gas barrier properties when employed in relatively thick layers, such as in films having a thickness of about 20 to 30 μm. Such thick layers of starch material are not suitable for use in packaging laminates however, since they become brittle and are prone to cracking and breaking upon handling, for example in the lamination process and when fold forming of the laminate into packages. Besides not being flexible in handling at manufacturing and distribution, laminates including such thick layers of starch would also be capable of absorbing more moisture, which would influence the gas barrier properties negatively.

From WO97/16312 it is known that very thin layers of starch applied on to a core layer may provide gas barrier properties, at least when employed together with an adjacent layer of plastics, which has been united with the starch barrier layer by extrusion coating of the plastics material. Two very thin layers of starch, applied in a quantity of 0.5 and 1 g/m2 respectively, dry weight, on to opposite sides of a core layer of paperboard and each extrusion coated with a layer of plastics, provided an oxygen gas barrier of 289 cm3/m2, per 24 h at 1 atm. Similarly, two layers of starch, applied in a quantity of 1 and 1.5 g/m2 respectively, provided an oxygen gas barrier of 141 cm3/m2, per 24 h at 1 atm. The results obtained were thus, comparable with the gas barrier properties of, for example, a 12 μm thick film of oriented PET, thus representing a “medium performance barrier” material.

The packaging laminate WO97/16312 is, however, merely a medium performance gas barrier material. This means that it may only be used for packaging of liquid food products during short time periods of cool storage. It is not hitherto known in the prior art to produce packaging laminates having high performance gas barrier properties from starch or starch derivative barrier materials. It would be much more desirable to be able to provide a packaging material having sufficient gas barrier properties for long time storage of liquid food products, i.e. for extended shelf life (ESL) at cool storage or even for aseptic storage. Such desirable high performance oxygen gas barrier properties are in the order of about 50 cm3/m2 at 24 h, 1 atm (23° C., 50% RH) or better, e.g. up to 30 cm2/m2 at 24h 1 atm, i.e. oxygen gas barrier properties comparable to those of, for example, PVOH, EVOH (ethylene vinylalcohol copolymer) or polyamides (PA) when employed at a thickness of the order of about 5 μm.

FR-A-2684922 discloses coating a polymer film such as polyester with a dispersion of amylose starch containing surfactant and drying the starch at a temperature of up to 180° C. Good gas barrier properties are obtained at coating levels of for instance 0.7 g(dry)/m². However, there is no indication that similar properties might be obtainable in a laminated packaging material having a paper or paperboard core.

We have now found that a laminated packaging material possessing adequate barrier properties, in particular against gases, may be produced using a method which lends itself to being carried out using conventional production equipment of the type employed in the production of packaging materials with aluminum foil as the barrier layer.

We have also now established that it is possible in a packaging laminate to obtain high performance oxygen barrier properties from the use of starch and similar materials.

### OBJECTS AND SUMMARY OF THE INVENTION

One object of the present invention is to obviate the above-related drawbacks inherent in the prior art laminated packaging material.

A further object of the present invention is to realize a novel laminated packaging material of the type described by way of introduction, in which the risk of crack formation in the core layer has been completely eliminated.

Yet a further object of the present invention is to realize a packaging laminate in which superior barrier properties against both gases, such as for example oxygen gas, against non-polar flavor and aromatic substances, and against light may be incorporated.

Still a further object of the present invention is to realize a laminated packaging material possessing superior barrier properties, in particular against gases, which may be produced using conventional production equipment employed in the production of packaging materials with aluminum foil as the barrier layer.

According to a first aspect of the invention, there is now provided a method of producing a laminated packaging material comprising a core layer of paper or paperboard and a barrier layer applied on one side of the core layer, characterized in that polymer dispersion of polymer solution is applied as a barrier layer on at least one side of a carrier layer and is dried during heating for driving off water, whereafter the carrier layer with the applied, dried barrier layer is combined and permanently united with one side of the core layer.

Preferably, the barrier layer is applied by coating with an aqueous polymer dispersion or solution. PVOH may be applied as an aqueous solution, while starch may be partially dispersed and partially dissolved in water.

The polymer preferably has functional hydroxyl groups, and may for instance be selected from among polyvinyl alcohol, ethylene vinyl alcohol, starch, starch derivatives, carboxyl methyl cellulose and other cellulose derivatives, or a mixture of two or more thereof.

The aqueous polymer dispersion or polymer solution applied as barrier layer may be dried and optionally cured at a temperature of approximately 80 to 200° C. For non-curing materials it is preferred to operate at a temperature of approximately 80 to 130° C.

Most preferably, materials such as PVOH are preferably first dried at from 80 to 160° C. (more preferably 140 to 160° C.) in a first step and are then cured at from 170 to 230° C. in a second stage resulting in an improved gas barrier at 80% RH. More preferably drying is at 150° C. and curing is at 225° C. Optionally, the carrier and barrier material may be cooled between the two steps.

A polymer with functional carboxylic acid groups may also be included. This may react with the polymer with functional hydroxy groups during the drying/curing process.

Suitably, the polymer with functional carboxylic acid groups is selected from among ethylene acrylic acid copolymer and ethylene metacrylic acid copolymers or mixtures thereof.

One particularly preferred barrier layer mixture is of polyvinyl alcohol and ethylene acrylic acid copolymer.

Optionally, the barrier layer is first dried and is then heated to a higher temperature so that the dried barrier layer is cured at a temperature of up to 190° C., preferably approximately 170° C.

The barrier layer is preferably applied on the carrier layer in an amount of approximately 0.5 to 20 g/m², more preferably 2 to 10 g/m², based on dry weight.

The carrier layer may consist of paper or plastics and preferred materials are described below.

In one option the carrier layer preferably consists of paper with a grammage of approximately 15 to 35 g/m², e.g. 15 to 25 g/m², more preferably 15 g/m².

The carrier layer bearing the barrier material and the core layer may be assembled together in various ways.

The carrier layer bearing at least one barrier layer may be combined and united with the core layer by extrusion of a layer of thermoplastics therebetween.

Where the carrier layer bears a barrier layer on one side thereof it therefore may be combined with the core layer by extrusion of a layer of thermoplastics between the carrier layer and the core layer.

An outer layer of thermoplastics, preferably polyethylene, is optionally applied on the barrier layer by means of extrusion.

When the carrier layer bears a barrier layer on or both sides it may be combined with the core layer by extrusion of a layer of thermoplastics between the core layer and the barrier layer.

If the carrier layer bears a barrier layer on both sides thereof, a layer of thermoplastic may then be applied to the outer layer of barrier material by extrusion.

The layer of plastics applied between the core layer and the carrier layer or a barrier layer may include a substance functioning as light barrier. This is especially preferred when the carrier layer is of paper or other visually non-transparent material.

By applying, in a separate production stage, an aqueous polymer dispersion or polymer solution as a barrier layer on at least one side of a carrier layer and drying the barrier layer during heating for driving off water, and thereafter combining and permanently uniting the carrier layer with the applied, dried barrier layer to one side of the core layer, there will be realized a laminated packaging material with a barrier layer possessing superior barrier properties.

Thanks to the fact that the barrier layer is not dried or cured at elevated temperature in connection with the lamination of the packaging material, the risk of excessive drying of the core layer of paper or paperboard—with consequential risk of crack formation in the core layer—is wholly eliminated.

Given that the plastic layer applied between the core layer and the paper layer may include a substance serving as light barrier, ideally carbon black, a light barrier layer will be realized whose unattractive black appearance may be concealed in a layer between the core layer and a thin paper layer carrying the barrier layer.

One advantage of the method according to this aspect of the present invention is that the barrier layer produced in a separate stage may be employed in the production of a laminated packaging material in a corresponding manner and using corresponding production equipment as are employed today in the production of packaging materials with aluminum foil as the oxygen gas barrier.

We have also now established that it is possible in a packaging laminate to obtain high performance oxygen barrier properties from the use of starch and similar materials.

Accordingly, the present invention now provides a packaging laminate having a paper or paperboard core and one or more gas barrier layers of starch or a starch derivative providing an oxygen gas barrier property of 50 cm³/m² at 24 h, 1 atm (23° C., 50% RH) or better, the gas barrier layer or layers having a dry coating weight or aggregate coating weight no more than 7 gm⁻². Preferably, oxygen barrier property provided by the starch or starch derivative layer is 40 cm³/m² at 24 h, 1 atm (23° C., 50% RH) or better. More preferably the oxygen barrier property is up to 30 cm³/m² at 24h, 1 atm (23° C., 50% RH), e.g. 10 cm³/m² at 24 h, 1 atm (23° C., 50% RH) or below.

Preferably, the packaging laminate comprises a layer of plastics polymer, preferably a thermoplastics, e.g. polyethylene, laminated directly with the said gas barrier layer. Most preferably, said polymer is LDPE. Other thermoplastics that may be employed include all other kinds of polyethylene (including LLDPE, ULDPE, VLDPE, MPE and HDPE), polyproplylene, and polyethyleneterephthalate.

The gas barrier layer is applied at a dry coating weight of up to 7 gm-2, e.g. from 0.5 to 5 gm-2, more preferably 0.5 to 3 gm-2, e.g. from 1.5 to 2 gm-2.

We prefer that the gas barrier layer be made entirely from natural materials but it is acceptable to include minor amounts of other polymeric materials which do not interfere with the desired properties. For instance the gas barrier layer may further comprise a minor amount of water soluble or water dispersible polymers having functional hydroxyl groups, e.g. polyvinyl alcohol, and carboxyl group containing polyolefins such as ethylene acrylic acid, or a mixture thereof. The amount of such materials may be from 0 to 30%, e.g. 0 to 20% or 0 to 10% by weight.

We have observed that when polyethylene is applied to a layer of starch at a high temperature, e.g. over 200° C., the gas barrier properties of the starch are improved and that under appropriate conditions can be made to reach or move further into a high performance level. One preferred method of obtaining optimal properties is to apply the starch or starch derivative not to a thick core layer as in WO97/16312 but to a separate carrier in accordance with the first aspect of the invention. Suitably then, the gas barrier layer is carried by a carrier layer of paper or plastics.

When paper is employed it is preferably thin, e.g. said carrier layer may be of paper having a surface weight of from 10 to 35 g/m², preferably from 10 to 25 g/m². The paper may also be coated beforehand with a layer of plastics.

After application of the starch, the carrier may be combined with a paper or paperboard material so that the packaging laminate comprises a core layer having said carrier layer on one surface side thereof. There may be one or more layers including a heat sealing layer on the other surface side of said core layer.

The surface of the carrier layer to which the starch or starch derivative is applied is preferably substantially impervious to said liquid vehicle.

The degree to which the surface is impervious to liquid may be measured by measuring surface adsorption, e.g. in Cobb units. (‘Cobb’=g(water)/m² adsorbed on to the surface in 60 seconds exposure to liquid water). Adsorption of other liquids could be measured in an analogous method. The method of measuring Cobb adsorption is defined in SCAN P12-64 and in TAPPI T441. The surface adsorption of plastics is generally about 1 Cobb, while a smooth paper surface will generally have an adsorption of about 20 to 30 Cobb. Suitably, for use in the invention the substrate surface should have an adsorption of 50 Cobb or less, preferably an adsorption of 30 Cobb or less, more preferably an adsorption of less than 20 Cobb or most preferably an adsorption of 10 Cobb or less, e.g. less than 5 Cobb.

Preferably, the surface of the carrier layer to which the starch or starch derivative is applied has a smoothness of 200 Bendtsen or better. The method of measuring Bendtsen smoothness is defined in SCAN (Scandinavian Pulp and Paper Norms) P21-67 and in TAPPI UM535.

Where the substrate is plastics or has a plastics surface, such desired smoothness is usually obtained, such as in, for example, a film of plastics or a plastics coated paper carrier layer.

One reason why a high barrier property was not achieved in WO97/16312 may be that the paperboard core layer lacked the requisite degree of impermeability so that the aqueous solution of starch which was employed may have penetrated the surface. This might have an adverse action in a number of ways. There may not then be a smooth and unbroken surface to the starch layer because of penetration as such into the paperboard. Alternatively, or additionally, drying of the paperboard to dry the starch layer may cause surface deformation of the paperboard and hence cracking of the starch layer. These problems are obviated when the starch is applied to a separate, smooth, impervious carrier layer which is subsequently laminated to the core layer.

The paperboard used in WO97/16312 would typically be expected to have had a surface smoothness of 500-600 Bendtsen. This may in itself have been sufficient to prevent the starch layer being smooth and unbroken or from having thin areas providing a path for oxygen transmission.

In order to avoid cracks, punctures or deformations in the starch or starch derivative layer, it is preferred that the surface on to which it is applied is smooth, e.g. that the substrate surface has a smoothness of 200 Bendtsen or better (i.e. less ), e.g. from up to 150 Bendtsen, most preferably about 100 Bendtsen.

The materials described as carriers for use with starch can also be used with the other barrier materials used according to the first aspect of the invention. However, generally a plastics film carrier is preferred when using starch and the use of a thin paper carrier is preferred for barrier materials such as PVOH which may be heated to temperatures above 100° C. for drying and curing.

Starch for use in the invention may be of any conventional type although certain starches provide better results than others under the conditions we have used. Modified potato starch is preferred, such as Raisamyl 306 (Raisio) which is hypochlorite oxidized. Other acceptable starches include corn starch and derivatives, such as Cerestar 05773 a hydroxypropylated corn starch.

Starch derivatives that are suitable for use in the invention include oxidized starch, cationic starch and hydroxypropylated starch.

It will be understood that when the gas barrier property of the packaging laminates of the invention is referred to as being provided by a particular material, e.g. starch or a starch derivative, this does not exclude the case where the gas barrier property is the result of an interaction between the stated material and an adjacent layer in the laminate, rather than a bulk property of the stated material viewed in isolation.

It may be that a contributing mechanism in the improvement in barrier property noted when polyethylene is applied at a high temperature to a layer of starch comes from penetration of polyethylene molecules into the starch, replacing water in starch crystals. Other polymers producing a similar effect may be used.

Said plastics layer may be applied to said starch or starch derivative by melt extrusion or may be applied as a pre-formed film by hot pressure lamination e.g. with a heated roller. Generally, any technique may be employed in accordance with this preferred embodiment that provides the required modification of the barrier property of the starch.

Preferably said plastics layer is bonded to the starch or starch derivative at a temperature of at least 200° C., preferably from 250 to 350° C., more preferably from 250 to 330° C.

The invention includes a packaging container or package formed using a packaging laminate as described or by a method as described according to the invention.

The present invention will now be described and illustrated in greater detail herein below with the aid of non-restrictive examples of methods, as well as packaging laminates obtainable by the method, according to preferred embodiments of the present invention and with reference to the accompanying drawings.

### BRIEF DESCRIPTION OF THE DRAWINGS

FIG. 1 schematically illustrates a method of producing a carrier layer with a barrier layer according to the present invention applied thereon.

FIG. 2 schematically illustrates a method of producing the laminated packaging material according to the present invention.

FIG. 3 is a cross sectional view through a laminated packaging material according to the present invention.

FIG. 4 is a perspective view from above of a conventional, configurationally stable packaging container which is produced from a laminated packaging material according to the present invention.

FIGS. 5(a, b, c, d) schematically illustrates cross-sections of four different packaging laminates according to specific embodiments of the invention.

FIGS. 6(a, b, c, d) schematically illustrates the methods of manufacturing of the respective packaging laminates as described in FIG. 5.

### DESCRIPTION OF THE PREFERRED EMBODIMENTS

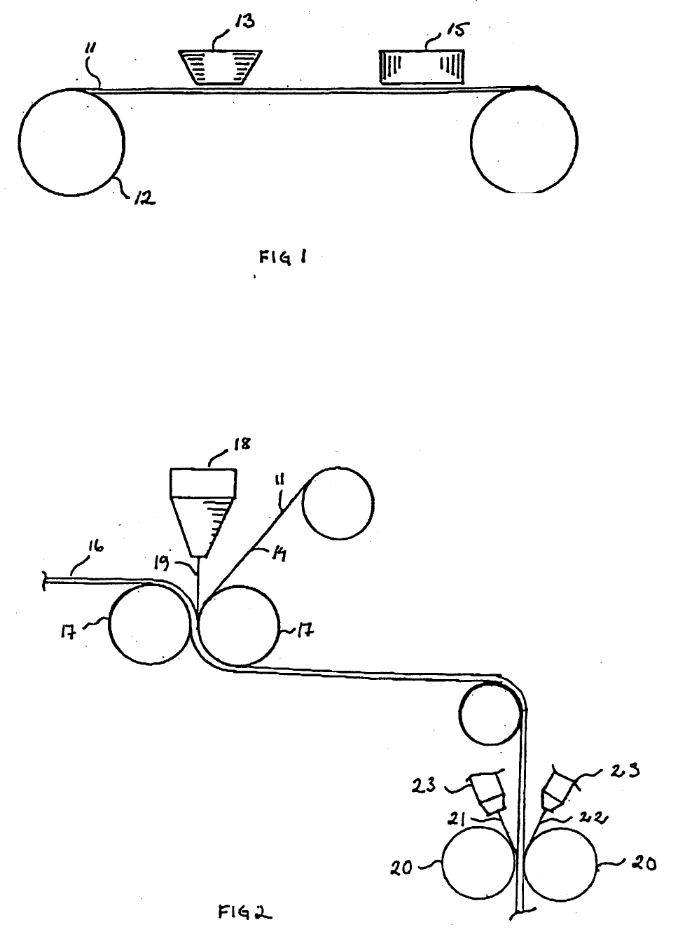

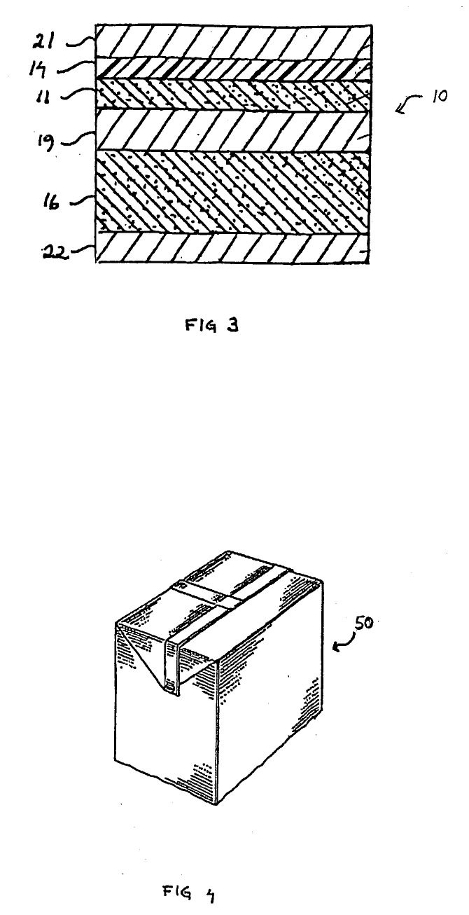

Referring to the Drawings, FIGS. 1 and 2 schematically illustrate a method according to the present invention chosen by way of example for producing a laminated packaging material 10 shown in FIG. 3. A web of a carrier layer 11, for example of thin paper, which may optionally be coated with a layer of plastic, is unwound from a magazine reel 12 and led past an applicator 13 (ideally a coating apparatus) disposed adjacent the web, by means of which at least one barrier layer 14 of aqueous polymer dispersion or polymer solution is applied on the one side of the carrier layer 11 in the form of a substantially cohesive barrier layer 14. In the case of a plastics coated paper carrier layer, the polymer dispersion or solution is preferably applied to the plastics coated side. The quantity of applied solution may vary, but is preferably in such an amount that a thoroughly integrated and substantially unbroken layer is formed after drying, for example approx. 0.5-20 g/m², preferably 2-10 g/m², based on dry weight.

Where PVOH is used, the carrier layer 11 preferably consists of a layer of thin paper with a grammage of approximately 10-35 g/m², preferably 10-25 g/m², more preferably 15-20 g/m², but may also be a plastic layer. However, thin paper enjoys the advantage that it does not alter dimensions on temperature increases in connection with drying and possible curing, which does not apply to plastics. Generally, where the polymer applied is to be cured at above about 130° C., the use of plastics film as carrier is not recommended.

The barrier layer 14 is applied on the carrier layer 11 in the form of an aqueous polymer dispersion or polymer solution which includes a polymer with those properties which are desired to be added to the packaging laminate in the form of a coated layer, for example a polymer with functional hydroxyl groups, for instance polyvinyl alcohol, ethylene vinyl alcohol, starch, starch derivative, carboxy methyl cellulose and other cellulose derivatives or mixtures thereof.

The barrier layer 14 may also include a hydrophobic polymer as described in WO96/01707, for example a styrene butadiene copolymer.

The barrier layer 14 may also include a polymer with functional groups which are reactive with the functional hydroxyl groups in the above-mentioned polymer, for realizing a cross-linked barrier layer 14. Such polymers may be polyolefins modified with carboxyl acid groups or graft copolymers with monomers containing carboxyl acid groups in an olefin homo- or copolymer. Alternatively, such polymers may be random selected copolymers of olefin monomers and monomers containing functional carboxylic acid groups, such as carboxylic acids, carboxylic acid anhydrides, metal salts of carboxylic acids or derivatives thereof. Specific examples of suitable functional polyolefins include polyethylene and polypropylene homo- or copolymers grafted with maleic acid anhydride, ethylene acrylic acid (EAA) or ethylene metacrylic acid (EMAA), or random selected copolymers.

It is particularly preferred that the barrier layer 14 includes a mixture of polyvinyl alcohol and ethylene acrylic acid copolymer. The mixing ratio between polyvinyl alcohol and ethylene acrylic acid copolymer in the barrier layer 14 should be such that the polyvinyl alcohol may form a blanket protection against gas transport in the packaging laminate, at the same time as the quantity of ethylene acrylic acid copolymer should be sufficient to form a cohesive phase which partly protects the polyvinyl alcohol and partly effectively counteracts or prevents the transport of liquid through the barrier layer 14.

The web of carrier layer 11 is led, after coating, further past a drying apparatus 15, e.g. an IR drier or a hot air drier which acts on the coated side of the carrier layer 11 for driving off water and drying, and possibly curing the applied barrier layer 14 at a drying temperature of approx. 80-100° C., preferably approximately 90-95° C., and, where applicable, a curing temperature for cross-linking the functional groups included in the coated polymer mixture, a temperature of up to approximately 190° C., preferably 170° C.

Finally, the finished carrier layer 11 with the applied barrier layer 14 is rolled up and may subsequently be stored or employed direct in a conventional lamination process for the production of a laminated packaging material 10 possessing superior barrier properties.

The carrier layer 11 with the applied barrier layer 14 may ideally be employed for the production of packaging material 10 in a corresponding manner and using corresponding production equipment to that employed in the production of packaging material with aluminum foil as the barrier layer. FIG. 2 shows a web of a configurationally rigid but foldable core layer with a grammage of approximately 100-500 g/m², preferably approx. 200-300 g/m², which may be a conventional fiber layer of paper or paperboard of suitable packaging qualities. The core layer 16 is led through the nip between two rotating rollers 17 and is united with a web of carrier layer 11 with dried or cured barrier layer 14, during the application—employing an extruder 18—of one or more layers of extrudable thermoplastic 19, preferably polyethylene, between the core layer 16 and the carrier layer 11. As shown, the barrier material 14 is on the outer face of the carrier layer but it may alternatively be on the inner face.

The thus laminated web is finally led through the nip between two rotating rollers 20 under the simultaneous application of thin layers 21, 22 of extrudable thermoplastic, preferably polyethylene, against both outer sides of the web employing extruders 23, the finished laminated packaging material 10 according to the present invention obtaining the cross-sectional structure schematically shown in FIG. 3. Alternatively, two extruders 23 may be disposed in sequence for the consecutive extrusion of thin layers 21 and 22 of thermoplastic on the respective outer sides of the laminated web.

The two plastic layers 21 and 22 have for their purpose, on the one hand, to protect the packaging material 10 from the penetration of moisture and damp from the outside and, also the crucial function of rendering the packaging material sealable by conventional so-called thermosealing, whereby mutually facing layers of plastic may be joined together under the supply of heat and pressure by surface fusion. The thermosealing operation realizes mechanically strong, liquid-tight sealing joints during the conversion of the packaging material into finished packaging containers.

The outer plastic layer 22 which is applied on the packaging material 10 on that side of the core layer 16 which, in the finished packaging container, is intended to be turned to face towards the outside may be provided with a suitable print of a decorative and/or informative nature for identifying a packed product.

From the laminated packaging material according to the present invention, liquid-tight, dimensionally stable packages 50 possessing superior oxygen gas barrier properties may be produced employing known packaging and filling machines which, in a continuous process, form, fill and seal the material into finished packages 50. An example of a such a conventional, packaging container 50 is shown in FIG. 4.

By first uniting the longitudinal edges of a web-shaped laminated packaging material 10 into a tube which is filled with the contemplated contents, whereafter individual packages 50 are separated from the web by repeated transverse sealing of the tube below the level of the contents. The packages 50 are separated from one another by incisions in the transverse sealing zones and obtain the desired geometric configuration, normally parallelepipedic, by a final fold formation and sealing operation.

It should be noted that the various packaging laminates according to the invention may comprise a multiple number of layers in addition to those shown in the drawings. It will thus be obvious to a person skilled in the art that the number of layers may vary as well as the description of the production of a laminated packaging material possessing superior barrier properties.

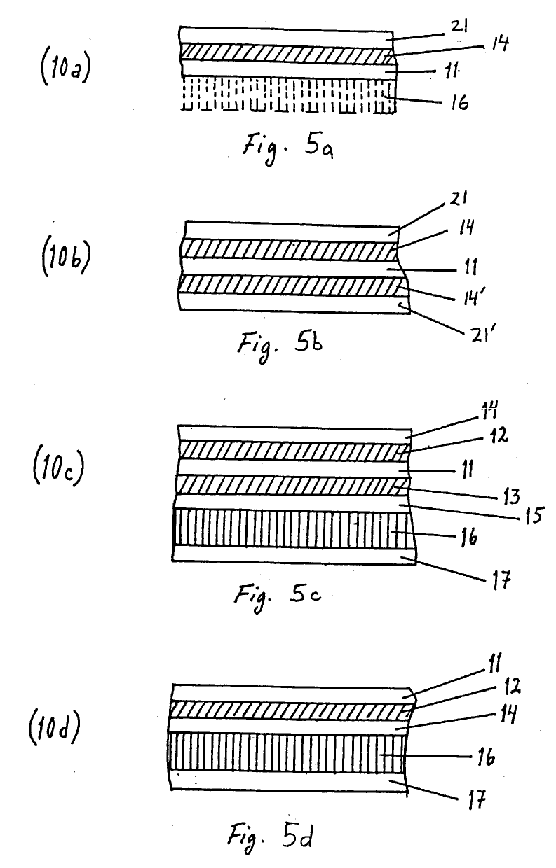

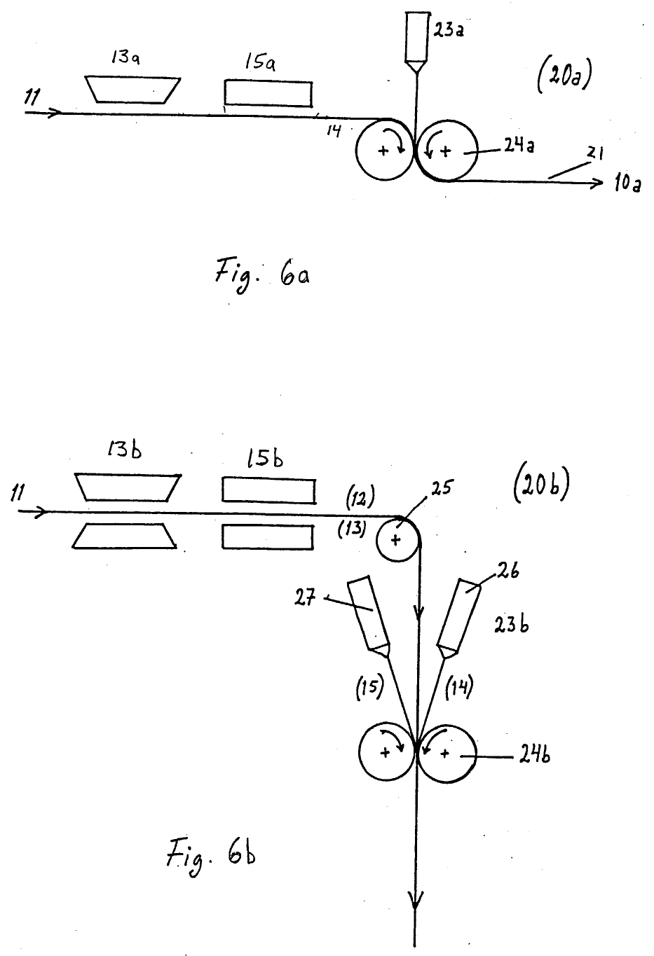

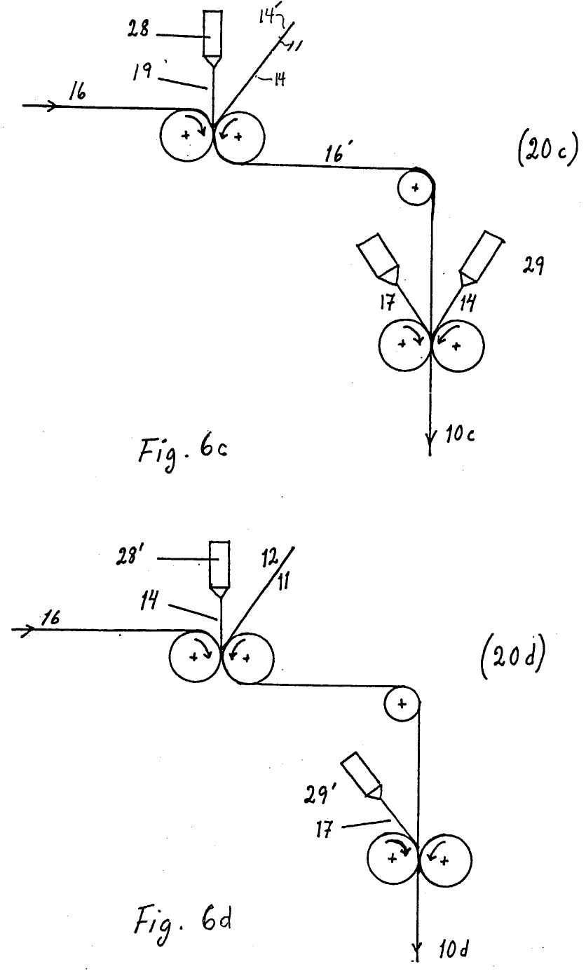

FIG. 5a thus schematically illustrates a cross-section of a packaging laminate according to a simple embodiment of the invention, carrying the generic reference numeral 10a, while FIG. 6a schematically illustrates the method (denoted 20a) of manufacturing of the laminate 10a. The packaging laminate 10a comprises a substrate layer 11, whose surface has a smooth, essentially non-absorbing texture. The substrate 11 may be a plastics film, or a thin paper having said surface qualities. A thin paper substrate having a surface weight of about 10-25 g/m2 is not able to absorb much from the starch solution both since it is very thin and since such commercially available thin papers usually have very smooth and glossy, hard surfaces. A particularly suitable paper for this purpose is so-called glassine paper, which, however, is rather expensive compared to other commercially available papers. Suitably, the paper may be MG Kraft paper (Munksjö) of 10 to 25 g/m2 surface weight, MG indicating that the paper is smooth on one surface, which is where the starch should be applied preferably. Most preferably, the substrate 11 is a plastics film since it has the most advantageous surface properties.

A thin layer of an aqueous solution or dispersion of starch is applied on to the upper side of a web of substrate layer 11, which is led in the direction of the arrow from a magazine reel (not shown) to a coating station 13a. A starch solution is preferably applied by means of liquid film coating technology, also called “dispersion coating” or “wet coating”, which is well known in the prior art of coating of aqueous solutions and dispersions, but also other coating methods are feasible according to the invention, e.g. spray coating. The aqueous starch solution is applied in such a quantity that the applied and dried starch layer 14 has a thickness/surface weight of from about 0.5 to about 3 g/m².

The web coated with aqueous solution is led further to a drying station 15a at which the web is dried with aid of a drying apparatus for removing water from the applied aqueous starch solution. Drying may be carried out by any conventional drying apparatus such as an infra-red (IR) drier or an air drier. Preferably, drying takes place at a temperature of about 80-100° C.

From the drying station the dried web, having an upper layer 14 of starch, is led further to an extruder station at 23a at which the web and starch layer is further laminated to a layer of plastics 21. The lamination of the starch surface to the plastics layer is carried out by means of surface fusion between plastics layer and the starch layer 12, which is obtained by simultaneous application of heat and the plastics. Preferably, molten polymer is extruded on to the dried starch layer at the same time as the web is led through the nip between two rotary cooling rollers 24a, thus forming a finished packaging laminate 10a as shown by a cross-section view in FIG. 1a, having an outer layer of plastic 21, laminated to the starch layer 14. The extruded plastics material is (preferably) a thermoplastic polymer, preferably a polyethylene and most preferably LDPE, which enables efficient conversion of the packaging laminate 10a into liquid-tight, dimensionally stable packages by so-called heat sealing. The extrusion temperature should be at least 200° C., preferably from about 250° C. to about 330° C.

Alternatively, said surface fusion between the starch layer 14 and the plastic layer 21 may be obtained by laminating a pre-manufactured film of thermoplastic to the dried starch layer 14 by means of simultaneous application of heat and pressure, preferably by means of leading the starch-coated substrate and the plastic film together through a hot roller nip, whereby the temperature supplied by the hot rollers is at least 200° C. and up to about 350° C., preferably from about 250° C. to about 330° C.

The three layer laminates so produced may then be laminated to a paperboard core 16 as shown in FIG. 2 to produce the packaging laminate 10a.

FIG. 5b schematically illustrates a cross-section of a packaging laminate 10b according to another embodiment of the invention and FIG. 6b schematically illustrates the method (denoted 20b) of manufacturing of the laminate 10b.

According to this embodiment of the invention, the substrate or carrier layer 11 is coated on both sides by an aqueous starch solution in the same way as described in the embodiment of FIGS. 5a and 6a.

Consequently, the packaging laminate 10b, which has been manufactured by the method of FIG. 6b, comprises a substrate layer 11 as defined above, preferably being a film of plastics, a thin layer of starch (14, 14′) applied on to each side of the substrate layer 11 and the outer layers of plastics (21, 21′) laminated to the outer sides of respective starch layer, by means of surface fusion of the outer plastics layers and the starch obtained by simultaneous application of heat as described above. With such a layer structure, a double gas barrier effect should be obtained, since two fusion bonded interfaces between starch and plastics are obtained.

Accordingly, with the method of FIG. 6b, a thin layer of an aqueous solution of starch is applied on to each side of a web of a substrate layer 11, which is led in the direction of the arrow from a magazine reel (not shown) to a coating station 13b. The starch solution is preferably applied by means of dispersion coating technology in such a quantity on to each side of the substrate layer 11, that the applied and dried starch layers 14, 14′ each have a thickness/surface weight of from about 0.5 to about 3 g/m².

The web coated with aqueous solution is led further to a drying station 15b at which the web is dried with the aid of a drying apparatus for removing water from the applied layers of aqueous starch solution. Preferably, drying takes place at a temperature of about 80-100° C., as described above.

From the drying station the dried web, having an upper layer 14 and a lower layer 14′ of starch, is led further via a bending roller 25 to an extruder station at 23b at which the web is further coated with a layer of plastics on each side. Thus the layers of plastics 21 and 21′ are applied by means of respective extruders 26, 27 operating on each side of the web. The molten polymer is extruded on to the dried starch layers at the same time as the web is led through the nip between two rotary cooling rollers 24b, in principle as described above, thus forming a finished packaging laminate 10b as shown by a cross-section view in FIG. 5b. The laminate 10b may be united with a core layer to form a finished packaging unit as shown in FIG. 2.

FIG. 5c schematically illustrates a cross-section of a packaging laminate 10c according to an alternative embodiment of the invention while FIG. 6c schematically illustrates the method (denoted 20c) of manufacturing of the laminate 10c.

A paper or paperboard core layer usually has a thickness of from about 100 μm up to about 400 μm, and a surface weight of approximately 100-500 g/m², preferably about 200-300 g/m².

According to the method 20c, a first web of the core layer 16, is led in the direction of the arrow from a magazine reel (not shown) to an extrusion lamination station 28 at which a second web of the substrate layer 11 having a dried layer of starch 14, 14′ applied on to each side is superposed and laminated to the core layer by means of an intermediate melt extruded lamination layer 19 of a thermoplastics polymer, preferably a polyethylene and most preferably LDPE.

The web of laminated core, starch and substrate layers 16′ is further led to an extruder station 29 at which an outer layer of thermoplastics 21, 22, such as preferably LDPE, is further extruded on to each side of the laminate 16′, such that the starch layer on the outer side of the substrate layer 11, which is opposite to the side which is laminated to the core layer, as well as the opposite side of the core layer 16, are both coated by the extruded thermoplastics, thus forming layers 21 and 22.

Suitable thermoplastics for the outer layer 14 are polyolefins, preferably polyethylenes and most preferably low density polyethylenes such as, for example LDPE, linear LDPE (LLDPE) or single site catalyst metallocene polyethylenes (m-PE). The outer layer 22, which eventually will form the outside of the packaging container manufactured from the packaging laminate, may alternatively be applied on to the core web 16 in a step before the coating and drying steps of the starch solution.

FIG. 5d schematically illustrates a cross-section of a packaging laminate 10d according to another embodiment of the invention while FIG. 6d schematically illustrates the method (denoted 20d) of manufacturing of the laminate 10d. The packaging laminate 10d is manufactured by applying and drying of a thin layer of an aqueous starch solution 12 on to the upper side of a substrate layer 11, which is constituted of a plastic film, as described in the method 20a above, in an initial step.

According to the method 20d, a first web of the core layer 16, is led in the direction of the arrow from a magazine reel (not shown) to an extrusion lamination station 28′ at which a second web of the substrate layer 11 having a dried layer of starch 14 applied on to one side 12, is super-posed such that the starch layer 14 is directed towards the core layer and laminated to the core layer by means of an intermediate melt extruded lamination layer of a thermos-plastic polymer, preferably a polyethylene and most preferably LDPE. The substrate layer 11, i.e. the plastics film, may form an outer layer of the packaging laminate to be directed inwards in a packaging container manufactured therefrom, thus providing a container inside layer. In a final extruder station 29′, the outer thermoplastic layer 17 is applied by means of extrusion coating.

A problem of the laminates described in WO97/16312 is that their manufacture would require completely different machinery to that of the paperboard laminates using aluminum foil as a gas barrier which are in conventional use. Such packaging laminates are made by extrusion laminating a paper board substrate to the barrier foil using polyethylene. In contrast, as can be seen from the above, a carrier layer of plastics or thin paper bearing a starch coating on one or both faces, with or without plastics already applied to the starch layer or to one or both of them, can simply be substituted for the aluminum foil in conventional machinery with minor adjustment. The preparation of the starch bearing carrier material can be done completely separately in another facility if need be so that an existing converting line in a factory can readily be adapted to use the new materials.

Thus a further important advantage by a preferred embodiment of the method illustrated, is that the steps of application and drying of the starch solution may be performed off the lamination processing line, thus avoiding costly modifications and re-construction of the lamination equipment in the manufacturing of packaging laminates having a core layer. By applying the starch layer on to a thin carrier layer such as a plastics film or a thin paper having a smooth, essentially non-absorbing surface, in the sub-sequence lamination with further layers of plastics and a core layer, the lamination operation may be performed using the same equipment and process as is used today, when laminating for example Al foil and inside layers.

From sheet or web-shaped, preferably pre-creased and color decorated, blanks of the packaging laminate 10, liquid-tight, dimensionally stable packages of the single-use disposable type are produced in accordance with conventional “form-fill-seal” technology, according to which the packages are formed, filled and sealed by means of modern, rational packaging and filling machines. From, for example, a web of the packaging laminate, such packages are produced in that the web is first reformed into a tube, by both longitudinal edges of the tube being united with another by heat sealing in a longitudinal overlap joint seal. The tube is filled with the pertinent contents, for example liquid food, and is divided into individual packages by repeated transverse sealings of the tube, transversely across the longitudinal axis of the tube, beneath the level of the contents in the tube. The packages are finally separated from one another by transverse incisions along the transverse seals and are given the desired geometric, normally parallelepipedic form by an additional forming and heat-sealing operation in a per se known manner.

Using the methods and materials described above by applying the aqueous solution of starch or a derivative on to a substrate layer for supporting the starch layer, which consists of a specifically chosen material, in combination with subsequent drying and lamination to a layer of plastics by heat fusion of the plastics surface, highly improved oxygen gas barrier properties are obtained in packaging laminates compared to those of WO97/16312. The improvement in the gas barrier properties of the laminated starch layer has been improved radically by a factor of about 10, into a so-called high performance barrier layer. The best gas barrier results have been obtained when the substrate layer consists of a polymer or has a polymer coated surface, but also a thin paper layer having a surface weight of approximately 10-25 g/m² with smooth, essentially non-absorbing surfaces, will provide improved gas barrier properties com-pared to those previously known in connection with starch.

When 2 grams of starch per m² is coated on to a plastic film (polyester-PET) and subsequently extrusion coated by a layer of LDPE, an oxygen gas barrier of only 9 cm³/m² at 24 h, 1 atm (23 C., 50% RH) is obtained. Similarly, a starch layer of 5 g/m² results in an oxygen barrier of about 4 cm³/m² and 7 g/m² in only 3 cm³/m².

The optimal gas barrier properties obtained in these examples when using a substrate layer of plastics or having a surface of plastics are, thus believed to be at least partly the result of the quality of the surface, i.e. smoothness and liquid repellence. While the mechanism of the effect obtained using a fusion bonded interface between starch and plastic layers is not fully understood, the optimal gas barrier properties may also partly be the result of there being such an interface formed on both sides of the starch layer, since the substrate layer to which the starch is applied is a plastics layer and the same kind of phenomenon may occur at this interface upon the application of heat to the starch and plastic layers.

The starch gas barrier layer according to the invention is advantageously applied in an amount of from about 0.5 to 3 g/m², dry weight. At amounts lower than 0.5 g/m², the tolerances of the layer thickness as well as the gas barrier properties will become less reliable. On the other hand, at amounts exceeding about 3 g/m², the risks that the starch barrier layer may become brittle and inflexible will increase. However, amounts applied of up to about 5 g/m², dry weight, are possible and for some type of packages and uses even higher amounts might be acceptable. The gas barrier property of the starch layer generally improves with increasing thickness. The optimal and preferred applied amount of starch ranges from about 1.5 to about 2 g/m².

### EXAMPLE 1

Packing laminates were prepared using a core of Billerud Duplex paperboard bearing 12 gm/m² LDPE on the outside.

These were prepared by extrusion coating LDPE at 325° C. on to “Duplex” paperboard (Billerud) having a surface weight of 280 g/m2 and a bending stiffness/flexural rigidity of 320 mN. The LDPE was LD273 (Dow), having a melt index of 6.5 to 7.5.

Extrusion of LDPE was carried out by means of a single screw extruder on to the paperboard just before passing between a cooling roller and a counter pressure roller. The cooling roller had a surface temperature of about 10-15° C.

Various combinations of carrier material and barrier material as detailed in Table 1 were prepared and each was laminated to the inside of the paperboard core by extrusion therebetween of a layer of 10 to 15 g/m² LDPE at 325° C. In preparing the barrier material/carrier material element starch was prepared for used in coating from a dry powder state by mixing 10 wt % of starch with water at ambient temperature to form a slurry. The slurry was heated with mixing to from 90 to 95° C. and kept at that temperature for 30 minutes. During heating the starch swelled.

If possible, e.g. with Raisamyl 306 oxidized starch (Raisio), the starch was cooled to ambient before use in coating. However, where this would have caused the starch to gel, e.g. with CERESTAR hydroxy-propylated starch, the starch would have been coated hot (60° C.).

A wet weight of approximately ten times the desired dry coating weight was applied to the substrate in web form using a liquid film coating/dispersion machine from Hirano of the knife-over-roll type, also known as a “comma-direct coater” or “bull-nose coater”.

For starch a first drying stage using IR heating to 80 to 100° C. was used to speed the drying process followed by a hot air drying step in which the starch coating was hot air dried at web speed of 1 m/min at a temperature of 110° C. Generally, a temperature of 100 to 130° C. is suitable depending on the linespeed.

In some cases the dried starch layer was extrusion coated with LDPE. About 25 g/m² of LDPE was extruded on to the dried starch layer at about 200 m/minute, 325° C., cooling roller at 10-15° C., as above. The distance between the extrusion die to the web was normally 10-30 cm. The extruded LDPE hit the web just before entering between the cooling roller and the counter pressure roller.

PVOH/EAA was applied as a solution in water and dried at 150° C. followed by curing at 225° C.

The results obtained in terms of oxygen gas barrier of the packaging laminate (adjusted to remove the contribution of OPET where necessary) are shown in Table 1.

TABLE 1

| | | Barrier | PE | O2 barrier |
|---|---|---|---|---|
| | | coating | coated | cm3/m2,24 h 1 |
| | | weight/ | on | atm, 23° C. 50% |
| Carrier | Barrier | Thickness | barrier | RH |
| 36 μm | Raisamyl | 2 μm | No | 13 |
| OPET (9) | | | | |
| 36 μm | Raisamyl | 5 μm | No | 62 |
| OPET (9) | | | | |
| 36 μm | Raisamyl | 7 μm | No | 5 |
| OPET (9) | | | | |
| 36 μm | Raisamyl | 2 μm | Yes | 9 |
| OPET (9) | | | | |
| 36 μm | Raisamyl | 5 μm | Yes | 4 |
| OPET (9) | | | | |
| 36 μm | Raisamyl | 7 μm | Yes | <1 |
| OPET (9) | | | | |
| 13 g/m2 | PVOH + | 5 g/m² | No | <1 |
| paper | 20% EAA | | | |
| 13 g/m2 | PVOH + | 5 g/m² | No | 8 |
| paper | 5% EAA | | | |

### EXAMPLE 2

PVOH with EAA was coated in a pilot plant onto LDPE-coated thin carrier layer paper of surface weight 13 g/m². The PVOH/EAA was dispersion coated onto the LDPE-coated side of the PE-coated thin carrier layer paper. The PVOH/EAA coating had a layer thickness of 5 microns. The LDPE layer was 10 g/m². Oxygen permeability was measured in cm³/m², 24 h, 1 atm.

| Web temp. | Curing temperature | O2 permeability | |
|---|---|---|---|
| (just after drying) | (air temp. in oven) | (23° C., 50% RH) | (80% RH) |

When coating PVOH with 20% EAA:

| | | | |
|---|---|---|---|
| 100 | 225 | 0.02-0.05 | 80-100 |
| 150 | 225 | 0.02-0.05 | 25-30 |

When coating PVOH with 5% EAA:

| | | | |
|---|---|---|---|
| 100 | 225 | 0.02-0.05 | 60-80 |
| 150 | 225 | 0.02-0.05 | 10-15 |

When coating PVOH with 0% EAA:

| | | | |
|---|---|---|---|
| 100 | 225 | 0.02-0.05 | dissolves |
| 150 | 225 | 0.02-0.05 | dissolves |

It will be obvious to a person skilled in the art that the present invention is not restricted to the illustrated embodiment, but that various modifications and alterations thereof may be put into effect without departing from the scope of the inventive concept as this is defined in the appended claims. For example, the packaging material structures illustrated are naturally, not restricted to the illustrated number of layers, but this number may be both greater and smaller, and may also be freely varied in response to the desired field of use of the packaging material.

We claim:

1. A method of producing a laminated packaging material comprising a core layer of paper or paperboard and a barrier layer applied on one side of the core layer, wherein an aqueous polymer dispersion or polymer solution is applied as a barrier layer on at least one side of a carrier layer and is dried during heating for driving off water, whereafter the carrier layer with the applied, dried barrier layer is combined and permanently united with one side of the core layer.

2. The method as claimed in claim 1, wherein the applied carrier layer is united to the core layer by means of lamination with a layer of plastic extruded between the core layer and the carrier layer.

3. The method as claimed in claim 1, wherein said barrier layer is applied by means of liquid film coating with an aqueous polymer dispersion or solution.

4. The method as claimed in claim 1, wherein said aqueous polymer dispersion or polymer solution applied as barrier layer includes a polymer with functional hydroxyl groups.

5. The method as claimed in claim 4, wherein said polymer with functional hydroxyl groups is selected from the group consisting of polyvinyl alcohol, ethylene vinyl alcohol, starch, starch derivatives, carboxyl methyl cellulose and other cellulose derivatives, and mixtures thereof.

6. The method as claimed in claim 1, wherein said aqueous polymer dispersion or polymer solution applied as barrier layer is dried and optionally cured at a temperature of approximately 80 to 200° C.

7. The method as claimed in claim 1, wherein said aqueous polymer dispersion or polymer solution applied as barrier layer is dried and optionally cured at a temperature of approximately 80 to 100° C.

8. The method as claimed in claim 1, wherein said aqueous polymer dispersion or polymer solution applied as barrier layer also includes a polymer with functional carboxylic acid groups.

9. The method as claimed in claim 8, wherein said polymer with functional carboxylic acid groups is selected from the group consisting of ethylene acrylic acid copolymer, ethylene metacrylic acid copolymer, and mixtures thereof.

10. The method as claimed in claim 9, wherein said barrier layer consists of a mixture of polyvinyl alcohol and ethylene acrylic acid copolymer.

11. The method as claimed in claim 8, wherein the dried barrier layer is cured at a temperature of up to 190° C.

12. The method as claimed in claim 1, wherein the barrier layer functions as gas barrier.

13. The method as claimed in claim 1, wherein said barrier layer is applied on the carrier layer in an amount of approximately 0.5 to 20 g/m² based on dry weight.

14. The method as claimed in claim 1, wherein said carrier layer consists of paper or plastic.

15. The method as claimed in claim 1, wherein said carrier layer consists of paper with a grammage of approximately 15 to 35 g/m².

16. The method as claimed in claim 1, wherein the carrier layer bearing at least one said barrier layer is combined and united with the core layer by extrusion of a layer of thermoplastics therebetween.

17. The method as claimed in claim 16, wherein said carrier layer bears a said barrier layer on one side thereof and is combined with the core layer by extrusion of a layer of thermoplastics between the carrier layer and the core layer.

18. The method as claimed in claim 1, wherein outer layers of thermoplastic are applied on the barrier layer and the core layer by means of extrusion.

19. The method as claimed in claim 16, wherein said carrier layer bears a said barrier layer on one or both sides and is combined with the core layer by extrusion of a layer of thermoplastics between the core layer and a said barrier layer.

20. The method as claimed in claim 19, wherein said carrier layer bears a said barrier layer on both sides thereof and a layer of thermoplastic is applied to the outer layer of barrier layer material by extrusion.

21. The method as claimed in claims 1, wherein the layer of plastic applied between the core layer and the carrier layer or a said barrier layer includes a substance functioning as light barrier.

22. A laminated packaging material which is produced by the method as claimed in claim 1.

23. A packaging container which is produced by fold formation of a sheet or web-shaped laminated packaging material as claimed in claim 22.

24. A packaging laminate having a paper or paperboard core and one or more gas barrier layers of starch or a starch derivative providing an oxygen gas barrier property of 50 cm³/m² at 24 h, 1 atm (23’ C., 50% RH) or better, said gas barrier layer or layers having a dry coating weight or aggregate coating weight no more than 7 gm².

25. A packaging laminate as claimed in claim 24, wherein the oxygen barrier property provided by the starch or starch derivative layer or layers is 30 cm³/m² at 24 h, 1 atm (23° C., 50% RH) or better.

26. A packaging laminate as claimed in claim 24, comprising a layer of plastics laminated directly with the said gas barrier layer.

27. A packaging laminate as claimed in claim 26, wherein said plastics is polyethylene, polypropylene or polyethylene terephthalate.

28. A packaging laminate as claimed in claim 24, wherein the gas barrier layer is applied at a dry coating weight of up to 5 gm⁻².

29. A packaging laminate as claimed in claim 28, wherein the gas barrier layer is applied at a dry coating weight of from 0.5 to 4 gm⁻².

30. A packaging laminate as claimed in claim 28, wherein the gas barrier layer is applied at a dry coating weight of from 0.5 to 3 gm⁻².

31. A packaging laminate as claimed in claim 28, wherein the gas barrier layer is applied at a dry coating weight of from 1.5 to 2 gm⁻².

32. A packaging laminate as claimed in claim 24, wherein the gas barrier layer further comprises a minor amount of polyvinyl alcohol, ethylene acrylic acid, or a mixture thereof.

33. A packaging container which is produced by fold formation of a sheet or web-shaped laminated packaging material as claimed in claim 24.
